(19) United States
(12) Patent Application Publication
(10) Pub. No.: US 2013/0156675 A1
(43) Pub. Date: Jun. 20, 2013

(54) PROCESS FOR PRODUCTION OF SILANE AND HYDROHALOSILANES

(71) Applicant: William C. Breneman, Moses Lake, WA (US)

(72) Inventor: William C. Breneman, Moses Lake, WA (US)

(73) Assignee: REC SILICON INC

(21) Appl. No.: 13/328,820

(22) Filed: Dec. 16, 2011

(51) Int. Cl. C01B 33/107; C01B 33/04; B01J 7/00

(52) U.S. Cl. 423/342; 422/129; 422/610; 423/347

(57) ABSTRACT

Embodiments of a system and process for the production of ultra-high purity silane and hydrohalosilanes of the general formula H_{y}SiX_{4-y} (y=1, 2, or 3) by a reactive distillation method are disclosed.

### FIELD

The present disclosure concerns embodiments of a system and reactive distillation method for producing silane and hydrohalosilanes of the general formula H_{y}SiX_{4-y} (y=1, 2, or 3).

### BACKGROUND

Mono-silane (SiH₄), chlorosilane (H₃SiCl) and dichlorosilane (H₂SiCl₂) are useful chemicals for the production of electronic devices based on high purity crystalline silicon. These silicon bearing gases are thermally decomposed to form the high purity silicon material. The production of high purity silane is presently practiced on a commercial scale by a process shown generally in FIG. 1 and generally described by U.S. Pat. No. 4,676,967 wherein first, metallurgical grade silicon is gasified by the reaction of hydrogen and silicon tetrachloride to form a mixture containing volatile trichlorosilane:

2H₂+3SiCl₄+Si→4HSiCl₃ (1)

Then, in a second step, trichlorosilane is converted to the high purity silane product in a series of distillation separations and catalytic redistribution reactions which also produce silicon tetrachloride as a co-product. The silicon tetrachloride is recycled to the first step.

4HSiCl₃→3SiCl₄+SiH₄ (2)

The silane is then pyrolyzed in any of several ways to form ultra-pure silicon and, if the process is close coupled, the by-product hydrogen is recycled to the first step.

Overall, the process is characterized as being highly efficient in the use of raw materials. However, the process is also characterized as being rather complicated and uses many distillation columns, some of which must operate at high pressure to achieve the desired results. It had been described in U.S. Pat. No. 3,968,399 that silane could be produced directly from trichlorosilane in a single step process wherein a solid redistribution catalyst also served as the contact surface in a fractional distillation column. While it was not so named in that patent, the process was the essential embodiment of a “reactive distillation” process in that both chemical reaction and distillation separation were conducted in the same apparatus.

However, there are several practical restrictions that must be addressed when combining distillation separation and the catalytic redistribution reaction. First, the kinetics of distillation, that is, the rate at which a vapor and liquid will interact to form an equilibrium mixture, is quite rapid, on the order of fractions of a second, whereas the chemical kinetics of the redistribution reaction, even with an outstandingly active catalyst, is measured in several minutes to achieve equilibrium. Thus the question is raised as to how to determine the amount of volume to devote to the reaction zone, to provide adequate space time for the reaction, amount of catalyst, etc. relative to the amount of vapor-liquid contact area or distillation separation stages. In the case of solid catalysts, the question becomes even more complex since the activity of the catalyst gradually changes with time, slowing the kinetics and thus altering the carefully thought out design based on the initial kinetic rates. Second, fixed beds of particles can develop flow restrictions over time due to tramp solids or from migration of smaller catalyst particles. This increased flow restriction must be addressed for a practical unit operation. Third, the temperature range at which the chemical reaction is presented with favorable kinetics and which do not result in undesirable side reactions, is rather narrow. In the context of a co-existent distillation operation, operating pressure and compositions restrain the location of the catalyst. In U.S. Pat. No. 3,968,399, for example, the rate of production of silane was very low because the reactive distillation operation was conducted at sub-ambient temperatures. Whereas U.S. Pat. No. 4,676,967 operates the redistribution reaction at temperatures chosen to maximize the chemical reaction rates and thus minimize the volume of catalyst required. Since the temperature within and associated with a distillation operation is a function of the vapor/liquid composition as well as the overall system pressure, the temperature limitation on the chemical reaction translates into limits on the system operating pressure as well as the location at which the chemical reagents are passed in contact with the catalyst. The addition of heaters or coolers to condition the reagent streams before they pass through the catalyst bed and to then reverse that heat effect before the reactor product returns to the distillation environment imposes an added energy and complexity burden on the process. Fourth, since rejection of thermal energy is necessary for any distillation separation, rejecting the energy to economically available ambient air or available cooling water is greatly preferred over rejecting the energy at sub-ambient or even cryogenic temperatures. This temperature restriction further limits the operating pressure and compositions in the reactive distillation system.

U.S. Pat. No. 6,905,576 puts forth a scheme whereby silane is produced in a reactive distillation system that utilizes an “intermediate condenser.” However, the inventors of U.S. Pat. No. 6,905,576 failed to realize that by purposefully restricting the production of the lower boiling components (SiH₄ and H₃SiCl) in the first reaction zone, the complexity of the process could be substantially reduced along with reduced refrigeration and process pumping requirements. Finally, in an economical process to produce silane, at least some portion of the process must be operated at elevated pressure in order to use economically available heat rejection means and to avoid sub-ambient temperatures as much as possible. While U.S. Pat. No. 3,968,399 was demonstrated at atmospheric pressure, the production rate was very low and the cooling requirements to effect the distillation meant a coolant temperature well below −70° C. U.S. Pat. No. 6,905,576 claims operation at elevated pressure, but achieves the higher pressure by requiring a gas pump (compressor) or by use of lower temperature refrigeration. The process described in U.S. Pat. No. 6,905,576 purposefully forces the production of silane in a “first redistribution reactor” which necessitates the use of either a low temperature condenser, to deliver only a condensed liquid, or a compressor to pump the vapor to the higher pressure. Higher pressures are best achieved by using a pump to transport liquid chlorosilane reagents through the system, rather than relying upon a compressor to pump the highly reactive silane gases. Compressing silane or chlorosilane vapors requires special and very expensive considerations for the compressor hardware.

Notwithstanding the overall goal to produce silane from silicon and hydrogen, it the process sequence should present a chemical labyrinth such that no compound except silane, or the desired hydrohalosilanes, can pass through to the final product. The process should present at least one method for removing any given contaminant from the silane. Since the number of contaminant possibilities is very large, a set of purification techniques should be used that, taken together, will result in no impurity being present at a level higher than about 100 parts per billion parts silane, and for some selected impurities such as boron and phosphorus, the level of impurities should be below about 20 parts per trillion parts silane in order to provide an ultimate silicon product acceptable for electronic applications. It is fortunate that only a few compounds have boiling points close to that of silane, such that distillation offers a very powerful tool for purifying silane. However, there are key impurities, mainly the hydrides of boron and phosphorus that boil too close to silane to permit the extreme purification required for ultra-pure silane useful in electronic applications. For these impurities as well as possibly others, especially those which may themselves be chemically transformed during the process, additional purification means should be included within the overall process sequence to assure that the final silane product is of the exceptional purity required for the most demanding applications. As each additional process step adds to the capital and operational costs of the process, a method which can combine or eliminate process steps or hardware would offer an attractive economic alternative.

### SUMMARY

Described herein are embodiments of a system and process that combine fractional distillation separation of hydrohalosilanes and catalytic redistribution of hydrohalosilanes in a novel configuration that minimizes the physical size and number of the process equipments, allows the use of an ambient heat sink for nearly all of the heat rejection, allows the redistribution catalyst to be monitored for effectiveness and changed out readily if it declines in activity, and incorporates a purification strategy of redundant means to remove any and all critical impurities from the silane to deliver an ultra-pure product. The detailed description will show how novel configurations of the process elements provide an ultra-pure silane product within the constraints of the constituent's physical properties and chemical stability while providing a process that is robust in design and is economic in terms of energy, raw materials and capital equipment utilization. The process also provides a product composition that has a lower halogen to silicon molar ratio than the reactant stream. In other words, if the reactant stream includes one or more hydrohalosilanes of formula H_{y}SiX_{4-y} where X is a halogen and y is 1, 2, or 3, then the product composition will include a significant concentration of H₂SiX_{4-z} where z=y+1. For instance, when the reactant stream includes trichlorosilane, the product composition will comprise a reduced amount of trichlorosilane and an increased amount of dichlorosilane compared to the reactant stream.

Embodiments of the system include a first multi-zone fractional distillation column, a first catalytic redistribution reactor, and a first pump operable to pump a first distillate stream from the distillation column into the redistribution reactor. The first multi-zone fractional distillation column includes a reactant stream inlet, a first distillate stream outlet, a first product flow inlet, a bottom outlet, and a vapor outlet. At least one condenser is in communication with the vapor outlet. The first catalytic redistribution reactor includes a vessel defining a chamber, an inlet and a product flow outlet spaced apart from the inlet. The catalytic redistribution reactor does not include includes a pressure equilibrium outlet or a vapor return outlet.

In one embodiment, the system further includes a second catalytic redistribution reactor, and a second pump operable to pump a condensate from the first multi-zone fractional distillation column into the second redistribution reactor. The second catalytic redistribution reactor includes a vessel defining a chamber, an inlet and a product flow outlet spaced apart from the inlet, but does not include includes a pressure equilibrium outlet or a vapor return outlet. In another embodiment, the system further includes a second multi-zone fractional distillation column with an inlet operably coupled to a product flow outlet of the second redistribution reactor, an outlet positioned above the inlet, a purge stream outlet, and a bottom outlet.

In some embodiments, a reactant stream including one or more hydrohalosilanes of formula H_{y}SiX_{4-y} where X is a halogen and y is 1, 2, or 3 is passed via a reactant stream inlet into a first multi-zone distillation column having at least a first distillation zone and a second distillation zone, wherein the first distillation zone is maintained at a temperature T₁ corresponding to a boiling point of the reactant stream at a pressure within the column. A first distillate stream is pumped from the second distillation zone via a distillate stream outlet into a first catalytic redistribution reactor; the second distillation zone is maintained at a temperature T₂ at which liquid and/or vapor in the second distillation zone has a halogen to silicon molar ratio between 2.8 and 3.2. A first product flow is produced by the first catalytic redistribution reactor, and the first product flow is returned to the first multi-zone distillation column at a point between the reactant stream inlet and the distillate stream outlet. Vapor is passed from an upper portion of the distillation column to a condenser to produce a condensate containing H_{z}SiX₄, where z=y+1.

In some embodiments, the condensate is pumped through a second fixed-bed catalytic redistribution reactor to produce a second product flow, which then passes into a second multi-zone fractional distillation column through an inlet positioned at a height corresponding to a distillation zone located within the second multi-zone fractional distillation column wherein the distillation zone has a temperature corresponding to a boiling point of the second product flow at a pressure within the region. Silane is withdrawn from the second distillation column through an outlet positioned above the inlet. In some embodiments, a purge stream containing gaseous impurities is withdrawn through a top outlet of the second distillation column.

### BRIEF DESCRIPTION OF THE DRAWINGS

In the drawings:

FIG. 1 is a block diagram of a presently practiced process for the production of silane on a commercial scale.

FIG. 2 is a schematic diagram of a system suitable for the production of silane.

FIG. 3 is a schematic diagram of a two-column separation system for the production of chlorosilane and dichlorosilane co-products.

FIG. 4 is a graph of mole fraction of products versus position from the bottom of one embodiment of a multi-zone fractional distillation column.

FIG. 5 is a graph of temperature versus position from the bottom of the multi-zone fractional distillation column of FIG. 4.

FIG. 6 is a graph illustrating expected equilibrium compositions of hydrochlorosilanes after passing a reactant stream having a given Cl:Si mole ratio through a catalytic redistribution reactor.

FIG. 7 is a graph of column temperature versus Cl:Si mole ratio for one embodiment of a multi-zone fractional distillation column operated at a pressure of 653 kPa.

### DETAILED DESCRIPTION

This disclosure pertains to that portion of the overall process for production of silane from metallurgical grade silicon and hydrogen wherein a mixture of hydrohalosilanes of formula H_{y}SiX_{4-y} where X is a halogen and y is 1, 2, or 3 are converted into silane and silicon tetrahalide. For example, trichlorosilane and silicon tetrachloride resulting from a gasification process, reaction (1), may be converted into silane and silicon tetrachloride, reaction (2). Intermediate products including dihalosilane (H₂SiX₂) and halosilane (H₃SiX) also can be isolated at various points in the process.

In particular, disclosed is a unique arrangement of two multi-zone fractional distillation columns combined with two fixed-bed catalytic redistribution reactors wherein the feed to the first reactor is controlled to have a halogen to silicon molar ratio greater than 2.8, such as between 2.8 and 3.2, and produce a condensate enriched in H₂SiX₂ and having a halogen to silicon molar ratio less than 2.0, which can be fed to a second catalytic redistribution reactor for further processing.

By this arrangement, which is achieved by design of the multi-zone distillation columns, there is a sufficiently low concentration of silane (SiH₄) produced in the first reactor that a total condenser operating with ordinary coolant temperatures can be used on the first multi-zone distillation column. By selecting the system operating pressure, and hence the fractionation column temperature profile, the combined distillation and reaction operation can be conducted in a stable and predictable fashion using ambient air or commonly available cooling water for the condenser duty.

The intermediate product of this first distillation/reactor combination is pumped through a second fixed bed catalytic redistribution reactor where silane is produced in a mixture of hydrohalosilanes. All of the mixed hydrohalosilane stream passing to the second multi-zone distillation column passes through this second reactor. The redistribution catalyst, most favorably a weak base, macroreticular ion exchange resin, readily removes boron impurities from the hydrohalosilanes. The reactor beds also act as large sand filters to trap traces of silica solids that form from traces of oxygen or moisture present in industrial processes. The silica also acts to attract boron and other metallic species by chemisorption. The catalytic redistribution reaction combined with the chemisorption and physical filtration action of the catalyst bed prevent electronically active impurities from passing into the silane purification system. Providing this secondary purification immediately prior to the final silane distillation offers a redundant means for removing impurities and further guarantees the production of the highest purity silane. The hyper-pure silane is recovered in a high efficiency multi-zone distillation column as a side-draw liquid, while a small amount of silane is rejected as a vapor along with non-condensable impurity gases through a partial condenser. The result of these combined features is a process which has reduced energy consumption, reduced capital equipment investment and a process operation which can be easily monitored for its performance. The latter is particularly important for maximizing the unit's production quantity and quality.

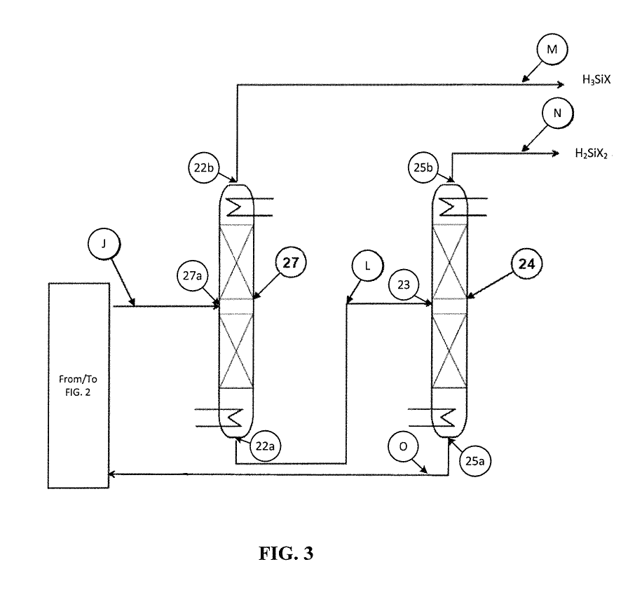

This disclosure also pertains to a process wherein the trihalosilane is produced by the hydrohalogenation of silicon or where the final products can also include minor amounts of ultra-pure dihalosilane (H₂SiX₂) or halosilane (H₃SiX). In the case of dihalosilane or halosilane, these components are present in enriched concentrations in the bottom streams of the multi-zone second distillation column. A side stream may be advantageously taken here and passed to a secondary set of distillation columns to deliver the desired amount and quality of these two hydrohalosilanes (FIG. 3).

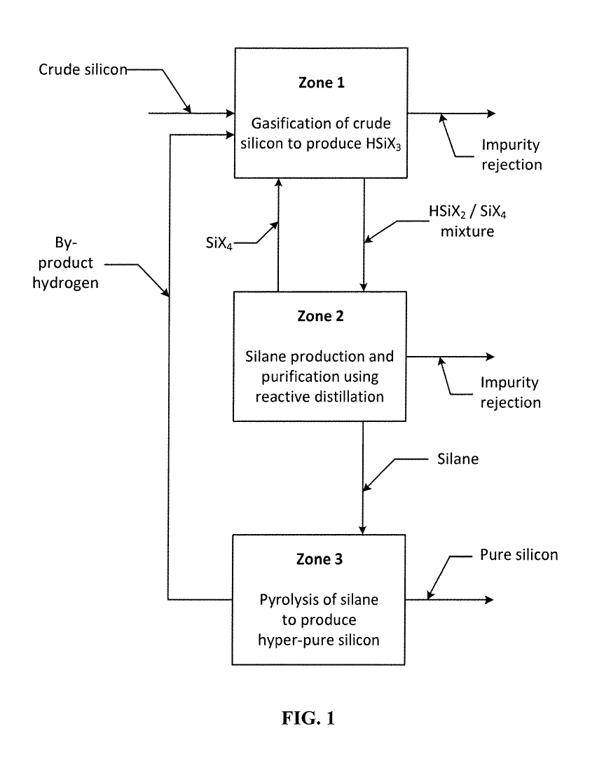

FIG. 1 is an overall block flow diagram of the process. It shows a silicon gasification zone (Zone 1) wherein metallurgical grade silicon is converted into a mixture of trihalosilane and silicon tetrahalide. In a reactive distillation zone (Zone 2) the trihalosilane is converted into silane and silicon tetrahalide, the latter of which may be recycled to Zone 1. In a final zone (Zone 3) silane is converted to hyper-pure polycrystalline silicon metal and hydrogen. The latter is recycled to the gasification zone (Zone 1). Optionally, a minor portion of the internal hydrohalosilane streams in Zone 2 may be diverted to a distillation separation zone where pure fractions of the individual halosilanes are obtained.

Impurities from the crude silicon feed stock are rejected in Zones 1 and 2. The impurity streams contain a halide value in addition to the impurity that is being rejected. To provide sufficient halide to replace that lost in both the impurity rejection as well as that contained in the by-product halosilane and/or dihalosilane streams, a make-up source of halide is required. The halide may be replenished by the addition of silicon tetrahalide, trihalosilane, hydrogen halide or halogen into Zone 1 of the process.

Optionally, the trihalosilane may be produced by hydrohalogenation of metallurgical grade silicon by the reaction of hydrogen halide and silicon as:

3HX+Si→HSiX₃+H₂ (3)

where X is a halogen. A significant co-product of reaction (3) is SiX₄ which is generally present at about 15% of the total halosilane stream. Using this means to produce HSiX₃ also requires an alternate outlet for the co-product SiX₄ resulting from the reactive distillation process for preparing silane, SiH₄. Among the alternative outlet means are conversion of the SiX₄ to pyrogenic silica, preparation of organosilane alkoxylates, silica-based resins and other useful materials. In any of the processes, the mixed HSiX₃/SiX₄ stream need not be further refined to alter the ratio of HSiX₃/SiX₄ prior to the reactive distillation process. Only a minor alteration of the configuration of the reactive distillation column is necessary, and much energy is saved by not further refining the crude mixture of halosilanes.

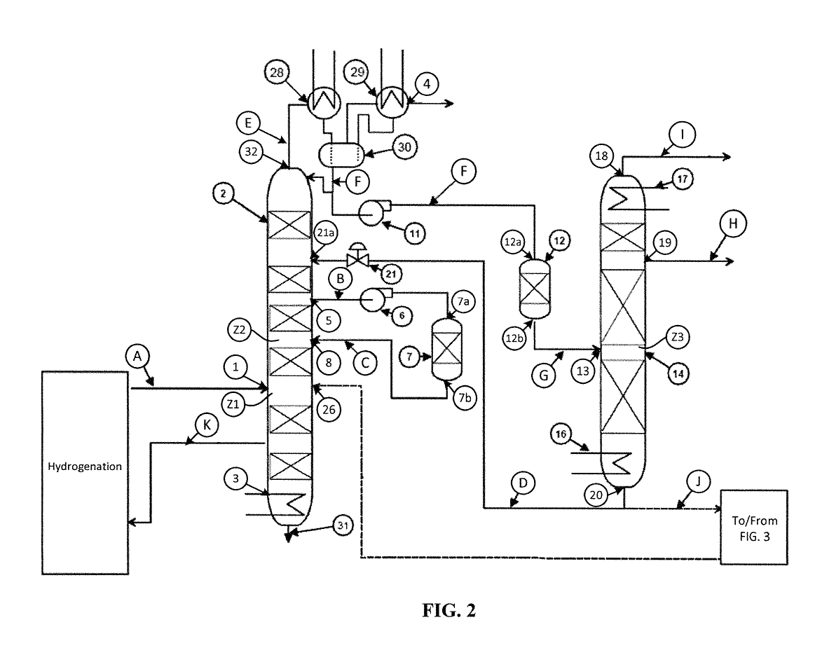

A grade of silane suitable for solar-grade silicon production can be produced by a process and system illustrated by FIG. 2. A reactive distillation zone is provided by a multi-zone fractionation column 2. The first multi-zone fractional distillation column 2 includes a vessel defining a plurality of distillation zones including at least a first distillation zone (Z1) and a second distillation zone (Z2) located above the first distillation zone (Z1), a reactant stream inlet 1, a first distillate stream outlet 5, a first product inflow inlet 8, a bottom outlet 31, and a vapor outlet 32. Column 2 further includes which has a reboiler 3 and a total condenser 28. In some arrangements, column 2 has two condensers 28, 29 in series as shown in FIG. 2, with hydrogen and/or nitrogen being vented at outlet 4. Condenser 29 removes remaining trace amounts of halosilanes before venting hydrogen/nitrogen. A collection tank/condensate receiver 30 is fluidly connected to condenser 28 and/or condenser 29. Condensate receiver 30 collects trace amounts of condensed halosilanes not removed in other fluid/vapor streams.

A reactant stream (A) comprising one or more hydrohalosilanes of formula H_{y}SiX_{4-y} where X is a halogen and y is 1, 2, or 3, from Zone 1, whether produced by the hydrogenation of SiX₄ or produced by the hydrohalogenation reaction, enters the first multi-zone distillation column 2 at a reactant stream inlet 1. In some embodiments, reactant stream (A) comprises a mixture of HSiX₃ and SiX₄. Reactant stream (A) may be a liquid, a vapor, or a combination thereof. Reactant stream inlet 1 is a positioned at a height corresponding to the first distillation zone (Z1). The first distillation zone (Z1) is maintained at a temperature T₁, which is close to a boiling point of the reactant stream at a pressure within the vessel. The second distillation zone (Z2) is maintained at a temperature T₂ at which liquid and/or vapor in the second distillation zone (Z2) has a halogen to silicon (X:Si) molar ratio between 2.8 and 3.2. T₂ is adjusted depending upon the pressure in the vessel. In some embodiments, the pressure within the vessel is from 450 kPa to 1750 kPa, and T₂ is from 60° C. to 150° C.

A first distillate stream outlet 5 is provided and a pump 6 is used to transfer a first distillate stream through a first catalytic redistribution reactor 7. The first catalytic redistribution reactor 7 includes a vessel defining a chamber, an inlet 7a, a product flow outlet 7b spaced apart from the inlet 7a, and a fixed-bed catalyst disposed within the chamber between the inlet 7a and the product flow outlet 7b. The product flow outlet 7b is in communication with the first product flow inlet 8 of column 2. In the arrangement shown in FIG. 2, inlet 7a is positioned in an upper portion of reactor 7, and outlet 7b is positioned in a lower portion of reactor 7. However, in another arrangement (not shown), inlet 7a is positioned in a lower portion of reactor 7 and outlet 7b is positioned in an upper portion of reactor 7. The first catalytic redistribution reactor 7 does not include a pressure equilibrium outlet or a vapor return outlet. The pump 6 provides a robust process that does not rely upon gravity to overcome flow resistance in the reactor 7. In the arrangement shown in FIG. 2, pump 6 is positioned between first distillate stream outlet 5 and first catalytic redistribution reactor inlet 7a. In another arrangement (not shown), pump 6 is positioned between first catalytic redistribution reactor outlet 7b and first product flow inlet 8.

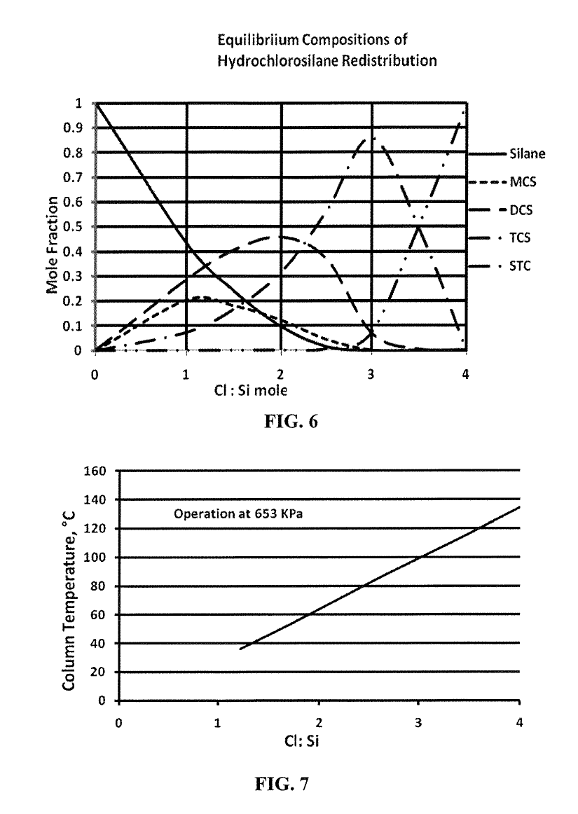

The reactor product (C) containing a mixture of hydrohalosilanes with the same X:Si ratio as stream (B), but with less trihalosilane than stream (B) and substantially free of silane, SiH₄, is returned to multi-zone fractionation column 2 at a first product flow inlet 8 positioned between the reactant stream inlet 1 and the first distillate stream outlet 5. In some arrangements, the position of first product flow inlet 8 is selected to minimize the quantity of first distillate stream (B) flowing through first distillate stream outlet 5. In some embodiments, reactor product (C) has at least 5% less trihalosilane than stream (B), at least 10% less trihalosilane than stream (B), or at least 20% less trihalosilane than stream (B). FIG. 6 is a graph illustrating one example of equilibrium compositions of hydrochlorosilane redistribution; the mole fraction of each component versus the overall Cl:Si mole ratio is shown.

A condensate (F) containing a mixture of hydrohalosilanes substantially free of silane and silicon tetrahalide is withdrawn as a condensed liquid from the total condenser 28 and is fed by a pump 11 to a second packed-bed catalytic redistribution reactor 12. Condensate (F) comprises HzSiX_{4-z} where z=y+1.

Second packed-bed catalytic redistribution reactor 12 includes a vessel defining a chamber, an inlet 12a, a product flow outlet 12b spaced apart from the inlet 12a, and a fixed-bed catalyst disposed within the chamber between the inlet 12a and the product flow outlet 12b. In the arrangement shown in FIG. 2, inlet 12a is positioned in an upper portion of reactor 12, and outlet 12b is positioned in a lower portion of reactor 12. However, in another arrangement (not shown), inlet 12a is positioned in a lower portion of reactor 12 and outlet 12b is positioned in an upper portion of reactor 12. The second catalytic redistribution reactor 12 does not include a pressure equilibrium outlet or a vapor return outlet. Second product flow (G) containing a mixture of hydrohalosilanes with the same X:Si ratio as stream (F), but with a substantial amount of silane, SiH₄, from the second redistribution reactor enters a second multi-zone fractional distillation column 14 at an inlet 13. In one arrangement, as shown in FIG. 2, pump 11 is positioned between condenser 28 and second catalytic redistribution reactor inlet 12a. In another arrangement (not shown), pump 11 is positioned between second catalytic redistribution reactor outlet 12b and second multi-zone fractional distillation column inlet 13.

The second multi-zone fractional distillation column 14 includes a vessel defining a plurality of distillation zones, an inlet 13 operably coupled to the product flow outlet 12b of the second catalytic redistribution reactor 12, an outlet 19 positioned above inlet 13, a partial condenser 17 positioned above outlet 19, a purge stream outlet 18 positioned above partial condenser 17, and a bottom outlet 20. Inlet 13 is positioned at a height corresponding to a first distillation zone (Z3) located within column 14 wherein the distillation zone (Z3) has a temperature corresponding to a boiling point of the second product flow (G) at a pressure within the region. Ultra-pure silane (H) is produced as a vapor or a condensed liquid product at outlet 19 positioned between inlet 13 and a partial condenser 17. A small purge stream (I) containing non-condensable gases (hydrogen, nitrogen, methane) boiling lower than silane along with a minor amount of silane, may be taken from a purge stream outlet 18 above partial condenser 17. Stream (I) amounts to less than 10% of stream (H) and is used to purge low boiling point gases from the system. Even though stream (I) may be unsuitable for the most demanding electronic quality applications, it is sufficiently pure to be useful for production of silicon for solar cells or for other applications not requiring the highest purity silane.

The bottoms stream (D), containing a mixture of hydrohalosilanes and substantially free of silane, flows through pressure control device 21 to the first multi-zone fractional distillation column 2, and enters at inlet 21 a, which is positioned above first distillate stream outlet 5. Silicon tetrahalide (K) is delivered as a bottoms product from column 2 to be recycled to the hydrogenation zone, or is available for sale. Outlet 31 of column 2 provides an outlet for draining the column and/or removing non-volatile components.

The feed point, or inlet, 1 of reactant stream (A) to distillation column 2 is determined by the expected composition of the feed mixture and the separation profile of column 2. The higher the concentration of HSiX₃, the higher in the column would be the feed point. As previously described, the optimal feed point would be at the location where the column temperature is close to the boiling point of the reactant stream (A) at the column's operating pressure. In some embodiments, the feed point is at a location where the column temperature is within 50° C. of the feed reactant stream's boiling point, such as within 40° C., within 30° C., or within 20° C. In practical applications, several feed points are usually provided so that adjustments may be readily made depending upon the efficiency of the upstream process. Likewise, the location of the first distillate stream outlet 5 may be altered from one of several points along column 2.

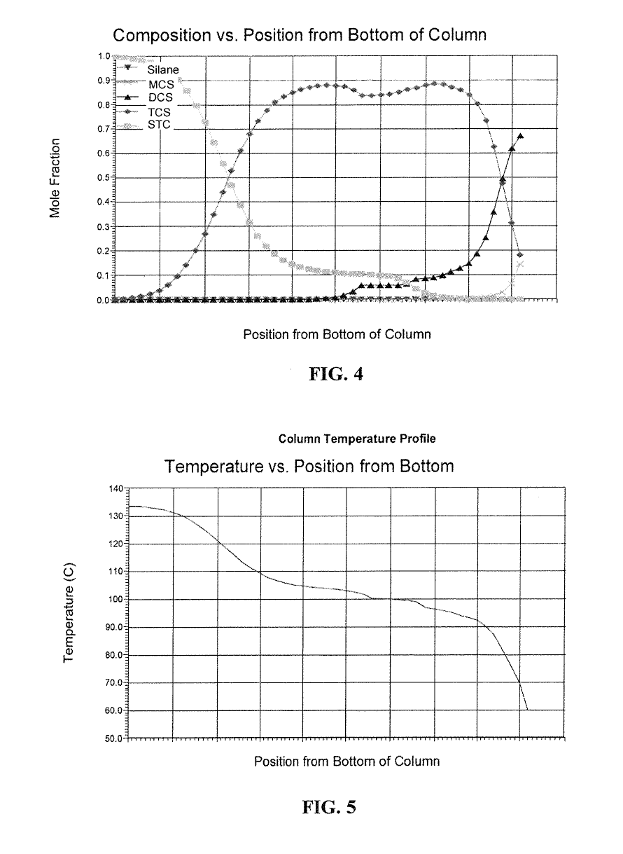

FIGS. 4 and 5 are graphs illustrating one example of liquid/vapor composition and temperature variations, respectively, as a function of the position within a multi-zone fractional distillation column such as column 2. Advantageously, the first distillate stream outlet 5 is positioned such that the distillate stream comprises at least some dihalosilane. In the example shown in FIGS. 4 and 5, first distillate stream outlet 5 may be placed at a position where the column temperature is 90° C. The outlet location is at a point where the column composition of hydrohalosilanes has a X:Si molar ratio of between 2.8 and 3.2, such as between 2.8 and 3.1. In some embodiments, the X:Si molar ratio is 3. At this molar ratio, the catalytic redistribution reaction more efficiently prepares H₂SiX₂, and very little silane is produced. This, in turn, allows a total condenser 28 to operate efficiently at ordinary coolant temperatures (ambient air or typical cooling water).

FIG. 6 is a graph illustrating the expected equilibrium mole fraction of each component present in a composition obtained by passing a reactant stream comprising chlorosilanes through a redistribution reactor, such as reactor 7 or reactor 12. The x-axis represents the Cl:Si mole ratio of the input stream, i.e., stream (B) as it flows into redistribution reactor 7, or stream (F) as it flows into redistribution reactor 12. The y-axis represents the output composition (i.e., stream (C) or stream (G)) from the redistribution reactor when the reactor is operating in a steady-state condition. Thus, when stream (B) has a Cl:Si mole ratio of 3, for example, the output composition (C) comprises primarily trichlorosilane, dichlorosilane, and silicon tetrachloride with little or no monochlorosilane or silane. When stream (F) has a Cl:Si mole ratio of 2 for example, stream (G) will include silane and monochlorosilane, as well as dichlorosilane and trichlorosilane. FIG. 7 illustrates the expected Cl:Si molar ratio as a function of temperature when a multi-zone fractional distillation column is operated at a pressure of 653 kPa.

The recycle stream (D) from the second distillation column 14 contains substantial amounts of halosilane (H₃SiX) and dihalosilane (H₂SiX₂), but is substantially free of silane, SiH₄. Stream (D) enters column 2 above the outlet 5 for first distillate stream (B), and thus prevents the X:Si ratio in first distillate stream (B) from falling below the target range of 2.8-3.2.

By selecting the operating pressure of first multi-zone fractional distillation column 2 to be from 450 to 1750 kPa, such as from 450 to 650 kPa, the temperature at the first distillate stream outlet 5 can be controlled to be between 60° and 150° C., such as between 60 and 90° C. This range is high enough for fast reaction kinetics and low enough to provide long operating life of the weak base macroreticular ion exchange resin, typically used as the catalyst. With a more thermally durable catalyst, a higher operating pressure and thus a higher side-draw temperature could be used. However, the X:Si ratio should remain in the range of 2.8-3.2 to prevent significant amounts of silane from being produced in this first reactor.

If halosilane and/or dihalosilane are to be co-produced, a minor amount of stream (D) may be diverted as stream (J) to a two-column separation system (FIG. 3). The system includes third and fourth distillation columns 27 and 24. Third distillation column 27 includes a vessel defining a plurality of distillation zones, an inlet 27a in communication with the bottom outlet 20 of second multi-zone fractional distillation column 14, a bottom outlet 22a located below inlet 27a, and a top outlet 22b located above inlet 27a. Inlet 27a is positioned at a height corresponding to a region located within column 27 wherein the region has a temperature corresponding to a boiling point of the first bottoms stream (J) at a pressure within the region.

Fourth distillation column 24 includes a vessel defining a plurality of distillation zones, an inlet 23 in communication with bottom outlet 22a to receive a bottoms stream (L) from third distillation column 27, a bottom outlet 25a located below inlet 23, and a top outlet 25b located above inlet 23. Inlet 23 is positioned at a height corresponding to a region located within the fourth distillation column wherein the region has a temperature corresponding to a boiling point of the second bottoms stream (L) at a pressure within the region.

As illustrated in FIG. 3, monohalosilane is produced as an overhead product (M) from third distillation column 27 while a stream (L) rich in dihalosilane is rejected from the bottom of the column 27 and passed to fourth distillation column 24. In column 24, dihalosilane is taken as a high purity overhead product (N) while the bottoms stream (O) containing trihalosilane and a small amount of silicon tetrahalide is combined with reactant stream (A) and returned to column 2 of the main reactive distillation system (FIG. 2). As these two additional distillation columns can be operated at a pressure intermediate between that of column 14 and column 2, no pumps are required to move the halosilanes through the process and the pressure is sufficiently high to allow conventional ambient cooling for the condensers.

Each of the catalytic redistribution reactors 7, 12 may also be provided with a means to reverse the flow direction. Flow reversal or back-flushing is performed periodically to remove tramp solid impurities such as silica which can form from traces of moisture entering the process.

The following non-limiting example demonstrates an implementation of this process.

### EXAMPLE

A process system arranged as in FIG. 2 is fed a mixed chlorosilane feed (A) consisting of 25% HSiCl₃ and 75% SiCl₄ at a rate of 28.57 kg-mole/hr to reactant stream inlet 1 of a multi-zone fractional distillation column 2 operating at a pressure of 600 kPa. From first distillate stream outlet 5, a liquid side draw (B) is taken at a rate of 66.46 kg-mole/hr. The composition of the side draw (B) was 2% H₂SiCl₂, 97.2% HSiCl₃ and 0.6% SiCl₄—resulting in a Cl:Si molar ratio of 2.96. The side-draw (B) is passed as a liquid through a packed bed reactor 7 containing a dimethlyamine-functional styrene-divinylbenzene macroreticular resin (DOWEX MWA-1). The reactor's product (C), a liquid mixture containing 0.01% SiH₄, 0.3% H₃SiCl, 8.7% H₂SiCl₂, 77.6% HSiCl₃, 13.3% SiCl₄ was returned to the first distillation column 2 at a point 8 located between reactant stream inlet 1 and first distillate stream outlet 5. A feed stream (D) being recycled from the bottom of a second distillation column 14 consisting of 15.18 kg-mole/hr of a liquid mixture containing 0.09% SiH₄, 17.0% H₃SiCl, 48.3% H₂SiCl₂ and 34.5% HSiC1₃ enters at inlet 21a of the first distillation column 2. A bottoms stream (K) consisting of a liquid mixture of 0.8% HSiCl₃ and 99.2% SiCl₄ is taken from the base of the first distillation column 2 at a rate of 26.45 kg-mole/hr. and is passed to the hydrogenation reaction section. The condensate (F) from a total condenser 28 on the top of the column 2 is taken at a rate of 16.80 kg-mole/hr and fed, using a pressure-boosting pump 11 to a second catalytic fixed bed reactor 12 operating at a pressure of 2600 kPa and a temperature of 35° C. The condensate stream (F) composition is 0.09% SiH₄, 11.6% H₃SiCl, 77.1% H₂SiCl₂ and 11.1% HSiCl₃. This stream (F), with a Cl:Si molar ratio of less than 2.0 is fed to the second catalytic redistribution reactor 12 where it is converted to a liquid mixture (G) consisting of 4.1% SiH₄, 10.2% H₃SiCl, 43.8% H₂SiCl₂ and 41.9% HSiCl₃. The output (G) of the second redistribution reactor 12 is fed to lower third of a second multi-zone fractional distillation column 14. The second column 14 operated at a pressure of 2516 kPa and a condenser temperature of −33.3° C. The bottoms stream (D) exits the reboiler 16 at a rate of 14.68 kg-mole/hr and is recycled to the first distillation column 2. A small purge stream (I) is drawn as a vapor from the column's condenser 17 at a rate of 0.01 kg-mole/hr. The purge stream (I) consists of 90% SiH₄ and 10% H₂. The main silane product (H) is drawn from outlet 19 of column 14 as a liquid side-draw at a rate of 2.13.0 kg-mole/hr and a temperature of −29.4° C. The silane product stream (H) has a composition of 99.998% SiH₄ with less than 1 ppm H₃SiCl and less than 20 ppm H₂. The purge stream can be used for non-critical silane applications, such as for the production of granular silicon for solar cells or controlled transmission coatings on architectural glass. The primary silane product (H) is of extreme purity and can be used for the most exacting applications such as the production of electronic grade polysilicon.

In view of the many possible embodiments to which the principles of the disclosed invention may be applied, it should be recognized that the described embodiments are only preferred examples of the invention and should not be taken as limiting the scope of the invention. Rather, the scope of the invention is defined by the following claims.

What is claimed is:

1. A system for producing hydrosilanes, comprising:
(a) a first multi-zone fractional distillation column (2) comprising
a vessel defining a plurality of distillation zones,
a reactant stream inlet (1),
a first distillate stream outlet (5) positioned above the reactant stream inlet (1),
a first product flow inlet (8) positioned between the reactant stream inlet (1) and the first distillate stream outlet (5),
a bottom outlet (31), and
a vapor outlet (32) positioned above the first distillate stream outlet (5);
(b) a first catalytic redistribution reactor (7) comprising
a vessel defining a chamber,
an inlet (7a),
a product flow outlet (7b) spaced apart from the inlet (7a), and
a fixed-bed catalyst disposed within the chamber between the inlet (7a) and the product flow outlet (7b), wherein the product flow outlet (7b) is in communication with the first product flow inlet (8) of the first multi-zone fractional distillation column (2), and wherein the first catalytic redistribution reactor (7) does not include a pressure equilibrium outlet or a vapor return outlet;
(c) a first pump (6) operable to pump a first distillate stream (B) from the first distillate stream outlet (5) into the first catalytic redistribution reactor (7); and
(d) a condenser (28) in communication with the vapor outlet (32) of the first multi-zone fractional distillation column (2).

2. The system of claim 1, further comprising a second condenser (29) in fluid communication with an outlet of the condenser (28).

3. The system of claim 1, further comprising a reactant source operably coupled to the reactant stream inlet (1) and capable of providing a reactant stream (A) to the first multi-zone fractional distillation column (2).

4. The system of claim 1, further comprising:
(d) a second catalytic redistribution reactor (12) comprising
a vessel defining a chamber,
an inlet (12a),
a product flow outlet (12b) spaced apart from the inlet (12a), and
a fixed-bed catalyst disposed within the chamber between the inlet (12a) and the product flow outlet (12b), wherein the second catalytic redistribution reactor (12) does not include a pressure equilibrium outlet or a vapor return outlet; and
(e) a second pump (11) operable to pump a condensate (F) from the condenser (28) into the second catalytic redistribution reactor (12).

5. The system of claim 4, further comprising:
(f) a second multi-zone fractional distillation column (14) comprising
a vessel defining a plurality of distillation zones,
a second multi-zone fractional distillation column inlet (13) operably coupled to the product flow outlet (12b) of the second catalytic redistribution reactor (12),
a second outlet (19) positioned above the inlet (13),
a purge stream outlet (18) positioned above the second outlet (19). and
a bottom outlet (20).

6. A method for producing hydrosilanes, comprising:
passing a reactant stream (A) comprising one or more hydrohalosilanes of formula H_{y}SiX_{4-y} where X is a halogen and y is 1, 2, or 3 into a first multi-zone fractional distillation column (2) comprising a vessel defining a plurality of distillation zones including a first distillation zone (Z1) and a second distillation zone (Z2) located above the first distillation zone (Z1), wherein the reactant stream (A) is passed into the first multi-zone distillation column (2) through a reactant stream inlet (1) positioned at a height corresponding to the height of the first distillation zone (Z1);
maintaining the first distillation zone (Z1) at a temperature T₁ that corresponds to a boiling point of the reactant stream at a pressure within the vessel;
maintaining the second distillation zone (Z2) at a temperature T₂ at which liquid and/or vapor in the second distillation zone (Z2) has a halogen to silicon molar ratio between 2.8 and 3.2;
pumping a first distillate stream (B) from the first multi-zone fractional distillation column (2) via a first distillate stream outlet (5) positioned at a height corresponding to the height of the second distillation zone (Z2) through a first fixed-bed catalytic redistribution reactor (7) that does not include a pressure equilibrium outlet or a vapor return outlet to form a first product flow (C), and then back into the first multi-zone distillation column (2) via a first product flow inlet (8) positioned below the first distillate stream outlet (5) and above the reactant stream inlet (1); and
passing vapor (E) from an upper portion of the first multi-zone fractional distillation column (2) to a condenser (28) to produce a condensate (F) comprising H_{z}SiX_{4-z} where z=y+1.

7. The method of claim 6, wherein the reactant stream (A) comprises trichlorosilane.

8. The method of claim 7, wherein the first product flow (C) comprises at least 5% less trichlorosilane than the first distillate stream (B).

9. The method of claim 7, wherein the condensate (F) comprises dichlorosilane.

10. The method of claim 6, wherein the pressure within the vessel is from 450 kPa to 1750 kPa.

11. The method of claim 10, wherein T₂ is from 60° C. to 150° C.

12. The method of claim 10, wherein the halogen to silicon molar ratio is 2.8-3.1.

13. The method of claim 6, further comprising:
pumping the condensate (F) through a second fixed-bed catalytic redistribution reactor (12) that does not include a pressure equilibrium outlet or a vapor return outlet to produce a second product flow (G), which subsequently passes into a second multi-zone fractional distillation column (14) comprising a vessel defining a plurality of distillation zones and including a second multi-zone fractional distillation column inlet (13) positioned at a height corresponding to a distillation zone (Z3) located within the second multi-zone fractional distillation column (14) wherein the distillation zone (Z3) has a temperature corresponding to a boiling point of the second product flow (G) at a pressure within the region; and
withdrawing silane (H) from the second multi-zone distillation column through a second multi-zone fractional distillation column outlet (19) positioned above the second multi-zone fractional distillation column inlet (13).

14. The method of claim 13, further comprising withdrawing a purge stream (I) comprising gaseous impurities from a top outlet (18) of the second multi-zone fractional distillation column (14).
